(19) United States
(12) Patent Application Publication
(10) Pub. No.: US 2026/0048699 A1
(43) Pub. Date: Feb. 19, 2026

(54) Inflatable Cargo Stabilization System

(71) Applicant: Adalberto Martinez, Paterson, NJ (US)

(72) Inventor: Adalberto Martinez, Paterson, NJ (US)

(21) Appl. No.: 19/293,265

(22) Filed: Aug. 7, 2025

Related U.S. Application Data
(60) Provisional application No. 63/683,717, filed on Aug. 16, 2024.

(51) Int. Cl. B60P 7/06

(52) U.S. Cl. CPC B60P 7/065

(57) ABSTRACT

An automated (i.e., autonomous) airbag-based cargo restraint system for securing cargo within a trailer during transport. The system includes a plurality of support frames mounted along the trailer walls, each support frame is configured to house or support one or more inflatable airbags. The airbags are formed from durable, tear-resistant material and are adapted to expand multi-directionally to conform to and support cargo of various shapes and sizes. A pressurized air supply system comprising a main air line and a plurality of branch air lines delivers air to each airbag via dedicated hose ports. A built-in inflation source regulates air flow to inflate and maintain the airbags in position. The support frames include load-distributing cross-member structures and channels for lateral repositioning along the trailer interior.

### CROSS REFERENCE TO RELATED APPLICATION

The present application claims priority to, and the benefit of, U.S. Provisional Application No. 63/683,717 which was filed on Aug. 16, 2024 and is incorporated herein by reference in its entirety.

### FIELD OF THE INVENTION

The present invention generally relates to cargo restraint systems for freight transportation. More specifically, the present invention relates to an automated (i.e., autonomous) airbag-based cargo securing system configured to protect and stabilize cargo during transit. The system comprises a plurality of support frames mounted within a trailer (i.e., tractor trailer or shipping container); each frame is dimensioned to house or support one or more inflatable airbags formed from tear-resistant, conformable material. The airbags are inflated using an onboard or external compressed air source and may be controlled manually or automatically via a valve or regulator system. The airbag assemblies are designed to conform to cargo surfaces and absorb dynamic forces, thereby reducing cargo shifting, minimizing damage, and improving transport efficiency and safety. Accordingly, the present disclosure makes specific reference thereto. Nonetheless, it is to be appreciated that aspects of the present invention are also equally applicable to other like applications, devices, and methods of manufacture.

### BACKGROUND

By way of background, in logistics and freight transportation, oftentimes, cargo is damaged during shipping, especially when a trailer (i.e., tractor trailer or shipping container) is involved in an accident, sudden braking, or tipping event. Such incidents can result in significant product loss, insurance claims, customer dissatisfaction, and operational inefficiencies.

Conventional cargo restraint methods include rigid tie-downs, straps, wooden bracing, dunnage, and inflatable void-fillers. While partially effective in static conditions, conventional solutions often fail to adequately conform to irregularly shaped loads or dynamically adjust to shifting forces during vehicle motion. Additionally, many traditional methods are labor-intensive, time-consuming to deploy, or unable to provide consistent, multi-surface protection. Accordingly, there is a need for an improved cargo restraint system that can provide reliable and scalable protection across a variety of cargo types and trailer (i.e., tractor trailer or shipping container) geometries.

Therefore, there exists a long-felt need in the art for a cargo restraint apparatus that can prevent cargo movement and damage during transportation events such as tipping, sudden braking, or collisions. There is a long-standing need for a cargo restraint system that provides multidirectional support around cargo loads. Further, there is a need in the art for a trailer (i.e., tractor trailer or shipping container) integrated system that uses automated (i.e., autonomous) or semi-automated (i.e., semi-autonomous) airbag inflation to conform to varying cargo shapes and sizes. Additionally, there is a need for a modular solution that enables repositionable support frames to be adjusted along trailer (i.e., tractor trailer or shipping container) interiors to accommodate different load configurations. Furthermore, there exists a need for a durable restraint system that is reusable, easy to operate, and minimizes reliance on disposable materials such as dunnage or shrink wrap. Finally, there is a need for a comprehensive airbag-based cargo stabilization system that improves operational safety, efficiency, and cost-effectiveness during freight transport.

The subject matter disclosed and claimed herein, in one embodiment, comprises an airbag-based cargo restraint system configured for installation inside a cargo trailer (i.e., tractor trailer or shipping container) or transport vehicle. The system includes a plurality of support frames mounted along the cargo trailer (i.e., tractor trailer or shipping container) sidewalls or floor channels. Each support frame is adapted to secure one or more inflatable airbags that expand around the cargo. A centralized air supply system includes a main air line conduit extending along the trailer (i.e., tractor trailer or shipping container)'s upper edge, distributing compressed air to a plurality of branch lines, each connected to a respective airbag. The system also comprises an onboard inflation source, such as a compressed air tank, regulated by a manual or automated (i.e., autonomous) valve assembly to selectively inflate or deflate the airbags as needed.

In one embodiment, each airbag is fabricated from reinforced vinyl or other tear-resistant material, capable of withstanding repeated inflation/deflation cycles. The airbags may include multiple internal segments or chambers to ensure even distribution of air pressure and adaptive conformity to irregular cargo shapes. The support frames may be constructed from powder-coated steel alloy or aluminum and may include an internal channel or track to enable for lateral adjustment within the trailer (i.e., tractor trailer or shipping container).

In this manner, the airbag-based cargo restraint system of the present invention addresses long-standing challenges in the logistics and transportation industries. The system reduces cargo damage during transit, decreases the labor and time required for securing freight, and provides a reusable, adjustable, and automated (i.e., autonomous) solution for a wide variety of cargo sizes and trailer (i.e., tractor trailer or shipping container) configurations. The system uses pneumatic inflation, modular support frames, and a conduit network to enhance shipping reliability, operational efficiency, and safety.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an automated (i.e., autonomous) airbag-based cargo restraint system for use within a cargo trailer (i.e., tractor trailer or shipping container). The system comprises a plurality of support frames, each of the plurality of support frames is configured to be mounted to or positioned adjacent to an interior wall of the cargo trailer (i.e., tractor trailer or shipping container) and to house at least one inflatable airbag, a plurality of inflatable airbags, each inflatable airbag is constructed from a durable, flexible material and is configured to expand in multiple directions to conform to a surface of a cargo load and provide lateral and vertical support, an air supply system comprising a main air line conduit configured to run along an upper region of the cargo trailer (i.e., tractor trailer or shipping container) and a plurality of branch air line conduits, each branch air line conduit is in fluid communication with a corresponding inflatable airbag, at least one inflation source is operably connected to the main air line conduit and is configured to deliver compressed air to the plurality of inflatable airbags via the plurality of branch air line conduits, wherein each inflatable airbag, when inflated, applies contact pressure to the cargo load to restrict movement of the cargo load within the cargo trailer (i.e., tractor trailer or shipping container).

In another embodiment, the support frame is a rigid or semi-rigid frame body configured to mount to a wall or floor channel of a cargo trailer (i.e., tractor trailer or shipping container). The support frame is configured to receive and secure at least one inflatable airbag, and a load distribution structure is integrated into the frame body, the load distribution structure includes at least one cross-member grid configured to distribute compressive forces applied by an inflated airbag.

In one embodiment, an inflatable airbag assembly for securing cargo in a transport trailer (i.e., tractor trailer or shipping container) is disclosed. The assembly comprises an inflatable body formed of reinforced vinyl or other tear-resistant material, a plurality of inflatable segments or chambers are disposed within the inflatable body, each chamber is adapted to distribute air pressure across multiple surfaces of a cargo load, a conduit port is operably connected to a branch air line for receiving compressed air, and a structural frame is adapted to constrain the direction of inflation of the inflatable body and ensure conformal contact with at least one of a side, rear, top, or corner surface of the cargo load.

In yet another embodiment, a method of restraining cargo within a cargo trailer (i.e., tractor trailer or shipping container) using an airbag-based system is described. The method includes positioning a plurality of support frames along interior sidewalls of the cargo trailer (i.e., tractor trailer or shipping container), placing one or more cargo loads on pallets within the trailer (i.e., tractor trailer or shipping container) and aligning the cargo loads between the plurality of support frames, inflating a plurality of inflatable airbags secured to the support frames by supplying compressed air from an onboard inflation source through a main air line and a plurality of branch air lines, regulating inflation pressure of each inflatable airbag to conform to surfaces of the cargo loads, and maintaining each inflatable airbag in an inflated state during transit to minimize movement of the cargo loads.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of airbag-based cargo restraint system of the present invention for truck trailers (i.e., tractor trailers or shipping containers) and smaller transport vehicles in accordance with the disclosed structure;

FIG. 2 illustrates an enlarged view of an inflated airbag of the airbag-based cargo restraint system of the present invention in accordance with one embodiment of the present invention;

FIG. 3 illustrates a top plan view of a cargo trailer (i.e., tractor trailer or shipping container) outfitted with the airbag-based restraint system of the present invention, in accordance with one embodiment of the invention;

FIG. 4 illustrates another perspective view of the airbag-based cargo restraint system deployed within the interior of a cargo trailer (i.e., tractor trailer or shipping container) in accordance with one embodiment of the present invention;

FIG. 5 illustrates an enlarged view of the air supply and distribution components of the cargo restraint system of the present invention in accordance with the disclosed structure;

FIG. 6 illustrates a flow chart depicting a process of dynamic airbag inflation using the cargo restraint system of the present invention in accordance with the disclosed structure; and

FIG. 7 illustrates a flow chart depicting a process of cargo restraining system deployment in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cargo restraint apparatus that can prevent cargo movement and damage during transportation events such as tipping, sudden braking, or collisions. There is a long-standing need for a cargo restraint system that provides multidirectional support around cargo loads. Further, there is a need in the art for a trailer (i.e., tractor trailer or shipping container) integrated system that uses automated (i.e., autonomous) or semi-automated (i.e., semi-autonomous) airbag inflation to conform to varying cargo shapes and sizes. Additionally, there is a need for a modular solution that enables repositionable support frames to be adjusted along trailer (i.e., tractor trailer or shipping container) interiors to accommodate different load configurations. Furthermore, there exists a need for a durable restraint system that is reusable, easy to operate, and minimizes reliance on disposable materials such as dunnage or shrink wrap. Finally, there is a need for a comprehensive airbag-based cargo stabilization system that improves operational safety, efficiency, and cost-effectiveness during freight transport.

The present invention, in one exemplary embodiment, is a method of restraining cargo within a cargo trailer (i.e., tractor trailer or shipping container) using an airbag-based system. The method includes positioning a plurality of support frames along interior sidewalls of the cargo trailer (i.e., tractor trailer or shipping container), placing one or more cargo loads on pallets within the trailer (i.e., tractor trailer or shipping container) and aligning the cargo loads between the plurality of support frames, inflating a plurality of inflatable airbags secured to the support frames by supplying compressed air from an onboard inflation source through a main air line and a plurality of branch air lines, regulating inflation pressure of each inflatable airbag to conform to surfaces of the cargo loads, and maintaining each inflatable airbag in an inflated state during transit to minimize movement of the cargo loads.

Reference will now be made in detail to the present preferred embodiments of the invention, examples of which are illustrated in the accompanying drawings. Wherever possible, the same reference numerals are used in the drawings and the description to refer to the same or like parts.

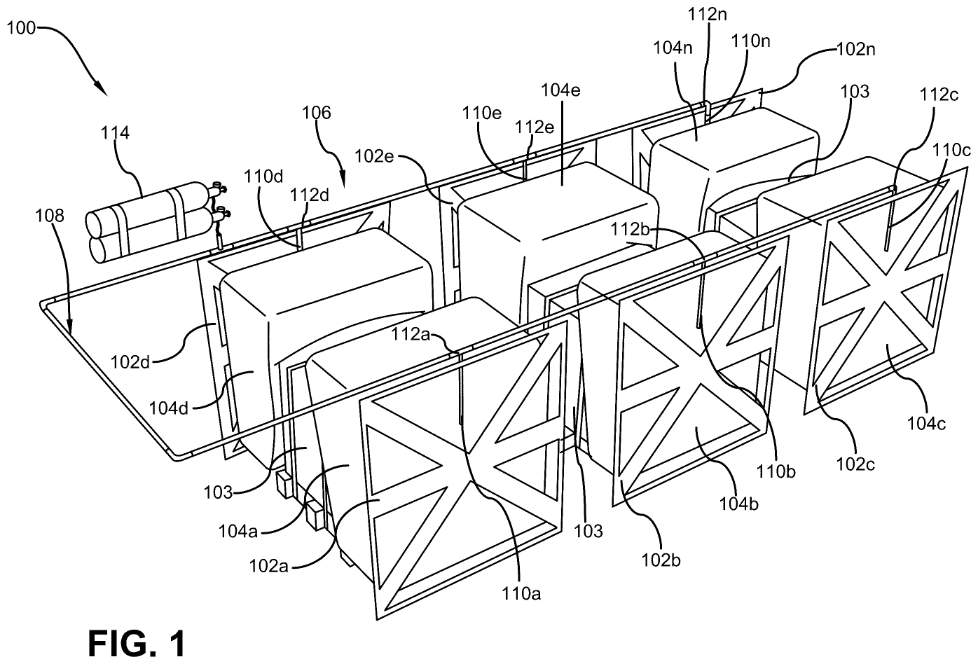

Referring initially to the drawings, FIG. 1 illustrates a perspective view of airbag-based cargo restraint system of the present invention for truck trailers (i.e., tractor trailers or shipping containers) and smaller transport vehicles in accordance with the disclosed structure. The airbag-based cargo restraint system 100 of the present invention is designed to prevent damage to cargo caused by tipping, shifting, or collisions by providing customized, snug support to cargo of any shape or size. More specifically, the automated (i.e., autonomous) airbag-based cargo restraint system 100 includes a plurality of support frames 102a-n wherein each support frame of the plurality of support frames 102a-n is mounted inside a trailer (i.e., tractor trailer or shipping container) wall as described later in the disclosure. The plurality of support frames 102a-n are fully repositionable and are configured to secure a plurality of airbags 104a-n. In the preferred embodiment, the support frames 102a-n are made from high strength powder-coated steel alloy or aluminum alloy and may have a coating of at least one of rubber or polymer to prevent cargo scratching or wear. The support frames 102a-n can be dimensioned to fit inside a trailer (i.e., tractor trailer or shipping container) and may include a channel for easy lateral movement along the trailer (i.e., tractor trailer or shipping container). Each support frame may have a cross-member grid (i.e., X cross member grid shown in FIG. 1) for providing rigidity and distributing load evenly on the trailer (i.e., tractor trailer or shipping container) walls.

At least one airbag of the plurality of airbags 104a-n is associated (i.e., connected) with a support frame and each airbag is made from a durable and tear resistant material such as vinyl fabric. Each airbag is configured to expand in all directions to wrap snugly around or to compress snugly against a cargo to prevent movement of the cargo 103. Each airbag of the plurality of airbags 104a-n is adapted to handle repeated inflation/deflation cycles and withstand common shipping stresses.

An air supply system 106 includes at least one main air line 108 which is configured to run along the top edges of a trailer (i.e., tractor trailer or shipping container) and is designed to distribute compressed air to each airbag of the plurality of airbags 104a-n. Specifically, each airbag is associated (i.e., connected) with a corresponding branch air line 110a-n, wherein the main air line 108 transfers the compressed air to the branch air lines 110a-n for inflating the airbags 104a-n via a corresponding hose port 112a-n.

An inflation source or inflator 114 is included in the automated (i.e., autonomous) airbag-based cargo restraint system 100 and is preferably in the form of at least one built-in pressurized onboard tank. The inflation source or inflator 114 can be automatically or manually activated to generate compressed air to inflate the airbags 104a-n.

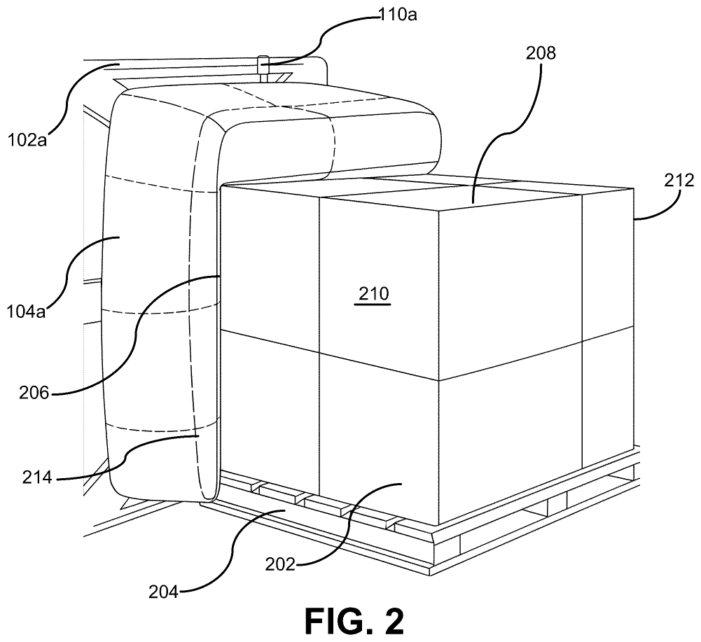

FIG. 2 illustrates an enlarged view of an inflated airbag of the airbag-based cargo restraint system of the present invention in accordance with one embodiment of the present invention. As illustrated, the cargo load 202 can consist of one or more stacked loading containers, boxes, or goods arranged in a cuboidal or any other geometric configuration and can be positioned atop a pallet 204. The pallet 204 may include parallel longitudinal support beams and lateral cross-planks, forming a standard load-bearing structure for forklift compatibility. The airbag 104a (exemplary) is shown in an inflated state and conforms to the rear surface 206 and top surface 208 of the cargo load 202. It should be noted that the airbag 104a can also conform to the side surfaces 210, 212 of the cargo load 202. In one embodiment, the airbag 104a can comprise a plurality of individual segments or chambers (i.e., as shown through dotted lines 214) to enable even pressure distribution across multiple surfaces of the cargo.

The airbag assembly 104a is structurally supported by the corresponding support frame 102a and may be a rigid or semi-rigid structure formed from steel alloy, aluminum, or composite materials. The branch air line or conduit 110a is used for inflating the airbag 102a from a normal state to the inflated state. It should be noted that the inflated airbag 104a along with the support frame 102a minimizes movement of the cargo load 202 during transportation by maintaining contact and absorbing shock forces through the inflated airbag assembly 104a.

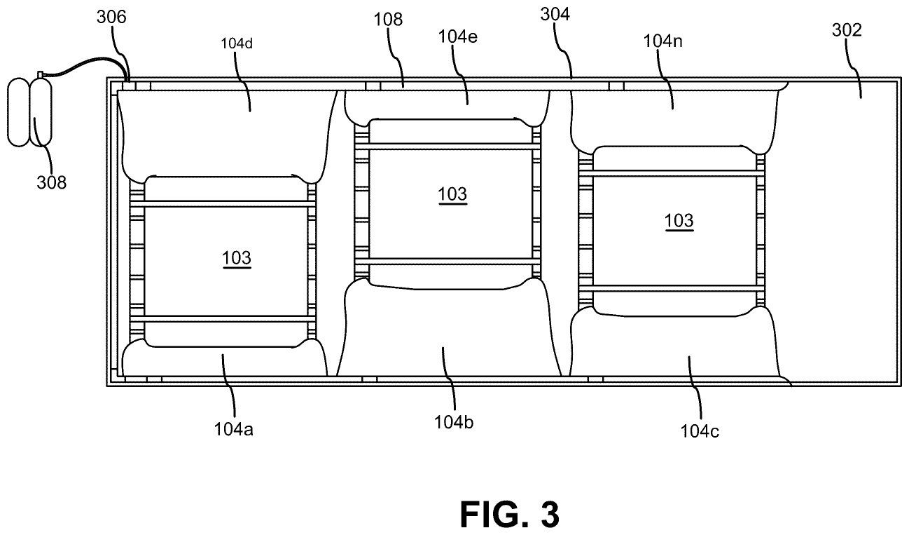

FIG. 3 illustrates a top plan view of a cargo trailer (i.e., tractor trailer or shipping container) outfitted with the airbag-based restraint system of the present invention, in accordance with one embodiment of the invention. The cargo trailer (i.e., tractor trailer or shipping container) 302 encloses a transport compartment configured to accommodate a plurality of cargo loads 103. Each cargo load can be positioned as per the requirements of the users and as an example, each cargo load 103 is positioned on a pallet (as described in FIG. 2) and is spaced apart longitudinally within the trailer (i.e., tractor trailer or shipping container) 302 to enable for the installation of inflatable support assemblies.

The inflatable airbag units 104a-n are partially expanded around the cargo loads 103 and each airbag unit is positioned to provide lateral and longitudinal support to the cargo. The airbag units 104a-n are arranged in sets (104a,d; 104b,e; 104c,n) between and beside the cargo loads, in contact with the sidewalls 304 of the trailer (i.e., tractor trailer or shipping container) interior.

The overhead air line conduit 108 is routed along the top longitudinal edge 306 of the trailer (i.e., tractor trailer or shipping container) 302, serving as a pressurized air distribution line for inflation of the airbags 104a-n. The air line conduit 108 is operatively connected to each airbag unit (104a-104n), enabling for selective or simultaneous inflation depending on operational needs as described in FIG. 1.

In the present embodiment, a control module (i.e., inflator) or external air tank housing 308 is included and may be positioned adjacent to the forward or rear bulkhead of the trailer (i.e., tractor trailer or shipping container), to provide pressurized air sources for inflation of the airbag units 104a-n.

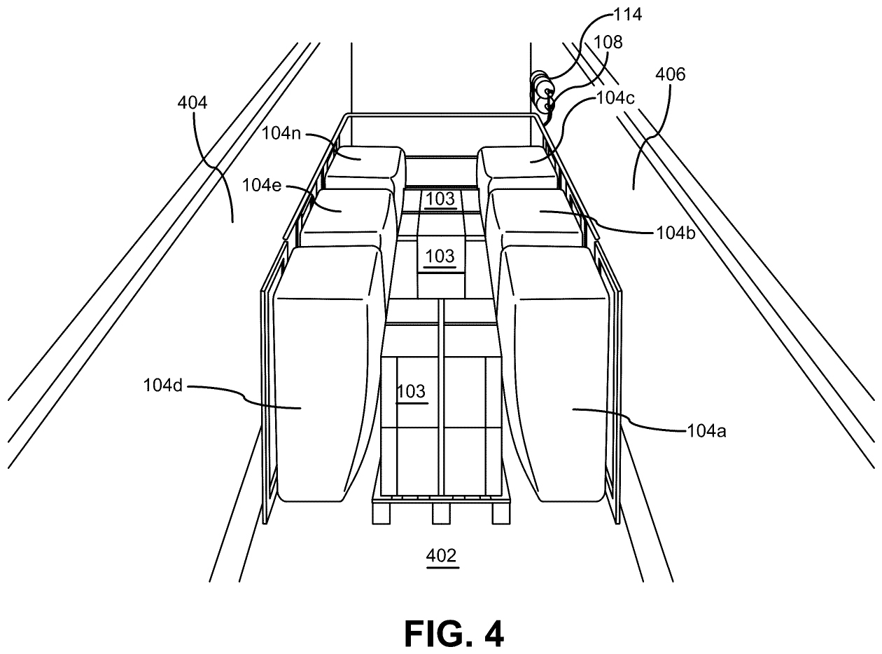

FIG. 4 illustrates another perspective view of the airbag-based cargo restraint system deployed within the interior of a cargo trailer (i.e., tractor trailer or shipping container) in accordance with one embodiment of the present invention. As illustrated, a plurality of palletized cargo loads 103 are arranged centrally along the trailer (i.e., tractor trailer or shipping container) floor 402. Each cargo load is positioned atop a standard transport pallet and is stabilized laterally using paired inflatable airbag units (104a,d; 104b,c; 104c,n). The paired airbag units are positioned on both sides of the corresponding cargo and extend vertically to provide coverage from the base to near the upper edge of the corresponding cargo.

The inflatable airbag units 104a-n are supported by structural support frames 102a-n mounted to or placed adjacent to the interior sidewalls 404, 406 of the trailer (i.e., tractor trailer or shipping container) 302. Each support frame includes an open grid or lattice construction to minimize weight while maintaining structural rigidity. The frames 102a-n are dimensioned to house the airbags 104a-n for proper alignment and spacing relative to the cargo load.

Each airbag is inflated from a pressurized air system 114 connected via the pneumatic conduit 108 routed along the upper periphery of the trailer (i.e., tractor trailer or shipping container) interior. The conduit 108 connects to each airbag and is supplied by one or more onboard air tanks positioned forward in the trailer (i.e., tractor trailer or shipping container).

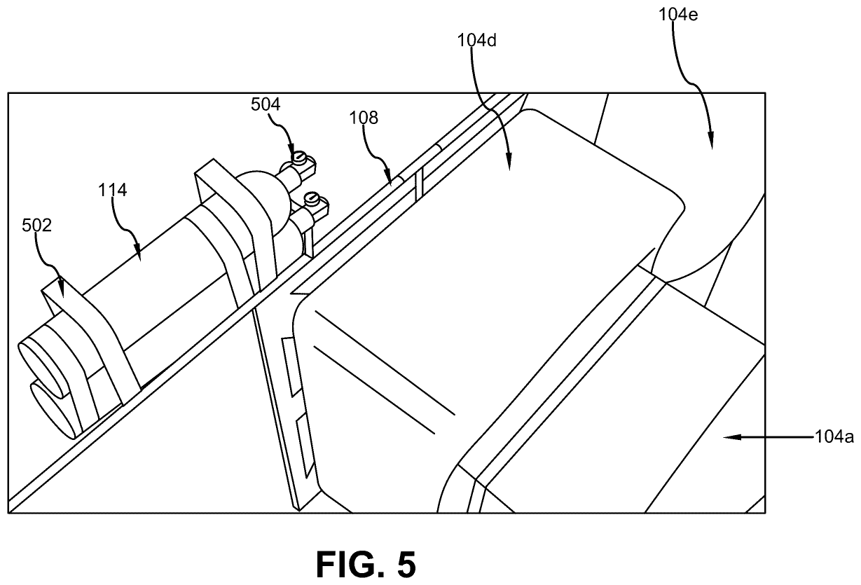

FIG. 5 illustrates an enlarged view of the air supply and distribution components of the cargo restraint system of the present invention in accordance with the disclosed structure. The pressurized tank assembly/inflation source or inflator 114 may include a pair of compressed air cylinders 502 which are secured using a support bracket 502. The inflation source or inflator 114 includes a pressure regulator and valve assembly 504, for controlled air discharge into the airbags 104a-n. The air line conduit 108 extends laterally from the assembly 114 and continues along a horizontal mounting rail or frame header to serve as the main air distribution channel.

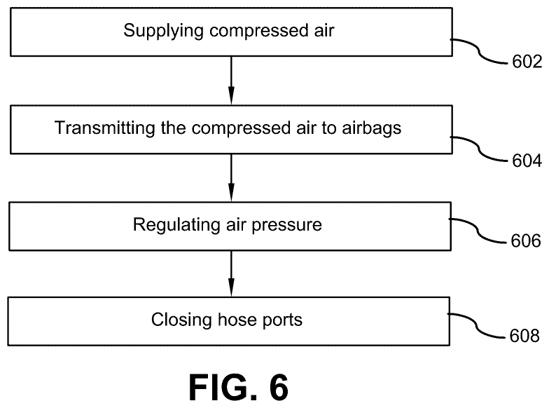

FIG. 6 illustrates a flow chart depicting a process of dynamic airbag inflation using the cargo restraint system of the present invention in accordance with the disclosed structure. Initially, compressed air is supplied either from onboard pressurized tanks or an external compressor (Step 602). Then, compressed air routes through the main conduit and branch air lines to each airbag (Step 604). Each airbag is inflated, and the pressure is regulated automatically using the pressure regulator and valve assembly 504 (FIG. 5) to avoid over-expansion of the airbags (Step 606). Once each airbag is inflated and optimal inflation is reached, corresponding hose port is closed to maintain the inflation of the airbag (Step 608).

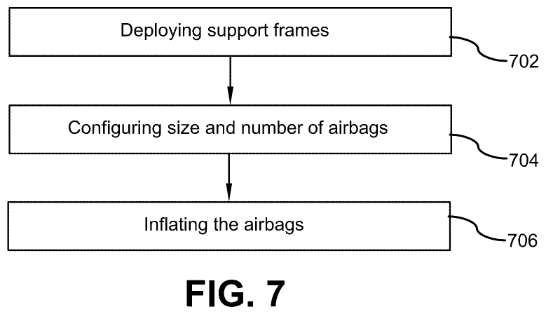

FIG. 7 illustrates a flow chart depicting a process of cargo restraining system deployment in accordance with the disclosed structure. Initially, support frames 102a-n (FIG. 1) are positioned along the sidewalls or mounted into floor/wall channels of a trailer (i.e., tractor trailer or shipping container) (Step 702). The support frames may slide or lock into pre-defined positions depending on trailer (i.e., tractor trailer or shipping container) width and cargo width. Then, the size and number of airbags are configured depending on at least load size, cargo size, and center of gravity of the trailer (Step 704). Finally, using the inflation source, the airbags are inflated for providing support to the cargo loads (Step 706).

The cargo restraint system 100 can be used in freight trailers, tractor trailers, shipping containers, trucks, or other transport vehicles. The airbags are integrated into repositionable structural frames which are mounted along the interior sidewalls of a transport shipping container or tractor trailer and when the airbags are inflated, the airbags apply lateral and vertical (i.e., longitudinal) pressure to cargo units or loads, thereby preventing movement, shifting, or damage during transit. The frame-mounted airbags can be selectively positioned according to the shape, size, and distribution of cargo, offering customizable configurations for various load profiles. The system reduces reliance on conventional restraints such as straps, dunnage, or blocking, and offers improved efficiency, safety, and reduction in damage-related claims.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “airbag-based cargo restraint system”, “cargo restraint system”, “modular inflatable cargo stabilization system”, and “system” are interchangeable and refer to the modular and inflatable cargo stabilization system 100 of the present invention.

Notwithstanding the forgoing, the modular and inflatable cargo stabilization system 100 of the present invention can be of any suitable configuration as is known in the art without affecting the overall concept of the invention, provided that it accomplishes the above stated objectives. One of ordinary skill in the art will appreciate that the modular and inflatable cargo stabilization system 100 as shown in the FIGS. are for illustrative purposes only, and that many other configurations of the modular and inflatable cargo stabilization system 100 are well within the scope of the present disclosure. Although the dimensions of the modular and inflatable cargo stabilization system 100 are important design parameters for user convenience, the modular and inflatable cargo stabilization system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An airbag-based cargo restraint system comprising:
a plurality of support frames;
a plurality of airbags;
an air supply system; and
an inflator for securing a cargo load in a trailer;
wherein each support frame of said plurality of support frames is mounted inside a trailer wall;
wherein said plurality of support frames are repositionable and are configured to secure said plurality of airbags;
wherein each support frame of said plurality of support frames having a cross-member grid for providing rigidity and distributing a load evenly on the trailer walls;
wherein at least one airbag of said plurality of airbags is connected with said each support frame;
wherein each airbag of said plurality of airbags expandable to compress against said cargo load to prevent movement of said cargo load;
wherein said each airbag of said plurality of airbags is adapted for repeated inflation and deflation cycles;
wherein said air supply system having at least one main air line to distribute compressed air to said each airbag of said plurality of airbags;
wherein said at least one main air line having a plurality of branch air lines;
wherein each of said plurality of branch air lines connected to an associated said each airbag of said plurality of airbags; and
further wherein said at least one main air line transfers compressed air from said inflator to said plurality of branch air lines for inflating said plurality of airbags.

2. The airbag-based cargo restraint system of claim 1, wherein said inflator having a pressurized onboard tank including compressed air for inflating said plurality of airbags.

3. The airbag-based cargo restraint system of claim 2, wherein said cargo load selected from the group consisting of stacked loading containers, boxes, and goods arranged in a geometric configuration.

4. The airbag-based cargo restraint system of claim 1, wherein at least two sides of said each airbag of said plurality of airbags in an inflated state conform to at least two surfaces of said cargo load.

5. The airbag-based cargo restraint system of claim 4, wherein said each airbag of said plurality of airbags having a plurality of individual chambers to enable even pressure distribution across multiple surfaces of said cargo load.

6. The airbag-based cargo restraint system of claim 5, wherein said plurality of support frames having a material selected from the group consisting of a steel alloy and an aluminum alloy.

7. The airbag-based cargo restraint system of claim 6, wherein said plurality of support frames having a coating selected from the group consisting of a rubber and a polymer.

8. The airbag-based cargo restraint system of claim 7, wherein said trailer wall is selected from the group consisting of a tractor trailer wall and a shipping container wall.

9. The airbag-based cargo restraint system of claim 8, wherein said plurality of support frames dimensioned to fit inside a shipping container.

10. An airbag-based cargo restraint system comprising:
a plurality of support frames;
a plurality of airbags;
an air supply system; and
an inflator for securing a cargo load in a trailer;
wherein each support frame of said plurality of support frames is mounted inside a trailer wall;
wherein said plurality of support frames are repositionable and are configured to secure said plurality of airbags;
wherein each support frame of said plurality of support frames having a cross-member grid for providing rigidity and distributing a load evenly on the trailer walls;
wherein at least one airbag of said plurality of airbags is connected with said each support frame;
wherein each airbag of said plurality of airbags expandable to compress against said cargo load to prevent movement of said cargo load;
wherein said each airbag of said plurality of airbags is adapted for repeated inflation and deflation cycles;
wherein said air supply system having at least one main air line to distribute compressed air to each airbag of said plurality of airbags;
wherein said at least one main air line having a plurality of branch air lines;
wherein each of said plurality of branch air lines connected to an associated each of said plurality of airbags; and
wherein said at least one main air line transfers compressed air from said inflator to said plurality of branch air lines for inflating said plurality of airbags;
wherein said plurality of airbags are partially expanded around said cargo loads; and
further wherein said each airbag of said plurality of airbags compressed against said cargo loads to provide lateral and longitudinal support to said cargo loads.

11. The airbag-based cargo restraint system of claim 10, wherein said inflator having a pressurized onboard tank including compressed air for inflating said plurality of airbags.

12. The airbag-based cargo restraint system of claim 11, wherein said cargo load is selected from the group consisting of stacked loading containers, boxes, and goods arranged in a geometric configuration.

13. The airbag-based cargo restraint system of claim 10, wherein at least two sides of said each airbag of said plurality of airbags in an inflated state conform to at least two surfaces of said cargo load.

14. The airbag-based cargo restraint system of claim 13, wherein said each airbag of said plurality of airbags having a plurality of individual chambers to enable even pressure distribution across multiple surfaces of said cargo load.

15. The airbag-based cargo restraint system of claim 14, wherein said plurality of support frames having a material selected from the group consisting of a steel alloy and an aluminum alloy.

16. The airbag-based cargo restraint system of claim 15, wherein said plurality of support frames having a coating selected from the group consisting of a rubber and a polymer.

17. The airbag-based cargo restraint system of claim 16, wherein said trailer wall is selected from the group consisting of a tractor trailer wall and a shipping container wall.

18. The airbag-based cargo restraint system of claim 17, wherein said plurality of support frames dimensioned to fit inside a shipping container.

19. A method of restraining cargo loads in a trailer, the method comprising the steps of:
providing an airbag-based cargo restraint system having a plurality of support frames, a plurality of airbags, an air supply system, and an inflator for securing a cargo load in a trailer;
mounting each support frame of said plurality of support frames inside a trailer wall, wherein said plurality of support frames are repositionable and are configured to secure said plurality of airbags;
connecting at least one airbag of said plurality of airbags with said each support frame, wherein each airbag of said plurality of airbags expandable to compress against said cargo load to prevent movement of said cargo load;
wherein said each airbag of said plurality of airbags is adapted for repeated inflation and deflation cycles;
wherein said air supply system having at least one main air line to distribute compressed air to said each airbag of said plurality of airbags;
wherein said at least one main air line having a plurality of branch air lines;
connecting each of said plurality of branch air lines to an associated said each airbag of said plurality of airbags; and
transferring compressed air from said inflator through said at least one main air line to said plurality of branch air lines for inflating said plurality of airbags.

20. The method of restraining cargo loads in a trailer of claim 19, wherein said plurality of airbags are partially expanded multi-directionally around said cargo loads, and further wherein each of said plurality of airbags compressed against said cargo loads to provide lateral and longitudinal support to said cargo loads.
